(19) United States
(12) Patent Application Publication
(10) Pub. No.: US 2025/0184075 A1
(43) Pub. Date: Jun. 5, 2025

(54) ADAPTABLE TIME-DOMAIN DENSITY OF A REFERENCE SIGNAL

(71) Applicant: QUALCOMM Incorporated, San Diego, CA (US)

(72) Inventors: Wei XI, Beijing (CN); Min HUANG, Beijing (CN); Liangming WU, Beijing (CN); Danlu ZHANG, San Diego, CA (US); Chao WEI, Beijing (CN); Hao XU, Beijing (CN); Chenxi HAO, Beijing (CN); Rui HU, Beijing (CN); Jing DAI, Beijing (CN)

(21) Appl. No.: 18/844,228

(22) PCT Filed: Jun. 1, 2022
(86) PCT No.: PCT/CN2022/096555

§ 371 Date: Sep. 5, 2024

(51) Int. Cl. H04L 5/00; H04B 7/06; H04W 72/02; H04W 72/0446

(52) U.S. Cl. CPC H04L 5/0051; H04B 7/0626; H04W 72/02; H04W 72/0446

(57) ABSTRACT

Various aspects of the present disclosure generally relate to wireless communication. In some aspects, a network entity may select a time-domain density configuration for a reference signal based at least in part on a transmission frequency associated with the reference signal. The network entity may transmit an indication of the time-domain density configuration to a user equipment (UE). Numerous other aspects are described.

### FIELD OF THE DISCLOSURE

Aspects of the present disclosure generally relate to wireless communication and to techniques and apparatuses for adaptable time-domain density of a reference signal.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3A and FIG. 3B illustrate a first example and a second example of a Doppler spectrum, in accordance with the present disclosure.

FIG. 4 illustrates an example of Doppler squint, in accordance with the present disclosure.

FIG. 5 illustrates an example of a wireless communication process between a UE and a network entity in a wireless communication network, in accordance with the present disclosure.

FIGS. 6A, 6B, and 6C illustrate, respectively, a first example, a second example, and a third example of different time-domain density configurations for a reference signal, in accordance with the present disclosure.

FIG. 7 is a diagram illustrating an example process performed, for example, by a network entity, in accordance with the present disclosure.

FIG. 8 is a diagram illustrating an example process performed, for example, by a UE, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### SUMMARY

Aspects generally include a method, apparatus, system, computer program product, non-transitory computer-readable medium, user equipment, base station, wireless communication device, and/or processing system as substantially described herein with reference to and as illustrated by the drawings and specification.

Some aspects described herein relate to a method of wireless communication performed by a network entity. The method may include selecting a time-domain density configuration for a reference signal based at least in part on a transmission frequency associated with the reference signal. The method may include transmitting an indication of the time-domain density configuration to a UE.

Some aspects described herein relate to a method of wireless communication performed by a UE. The method may include obtaining an indication of a time-domain density configuration associated with a reference signal. The method may include transmitting or receiving the reference signal based at least in part on a transmission frequency associated with the reference signal and the time-domain density configuration.

Some aspects described herein relate to an apparatus for wireless communication at a network entity. The apparatus may include a memory and one or more processors coupled to the memory. The one or more processors may be configured to select a time-domain density configuration for a reference signal based at least in part on a transmission frequency associated with the reference signal. The one or more processors may be configured to transmit an indication of the time-domain density configuration to a UE.

Some aspects described herein relate to an apparatus for wireless communication at a UE. The apparatus may include a memory and one or more processors coupled to the memory. The one or more processors may be configured to obtain an indication of a time-domain density configuration associated with a reference signal. The one or more processors may be configured to transmit or receive the reference signal based at least in part on a transmission frequency associated with the reference signal and the time-domain density configuration.

Some aspects described herein relate to a non-transitory computer-readable medium that stores a set of instructions for wireless communication by a network entity. The set of instructions, when executed by one or more processors of the network entity, may cause the network entity to select a time-domain density configuration for a reference signal based at least in part on a transmission frequency associated with the reference signal. The set of instructions, when executed by one or more processors of the network entity, may cause the network entity to transmit an indication of the time-domain density configuration to a UE.

Some aspects described herein relate to a non-transitory computer-readable medium that stores a set of instructions for wireless communication by a UE. The set of instructions, when executed by one or more processors of the UE, may cause the UE to obtain an indication of a time-domain density configuration associated with a reference signal. The set of instructions, when executed by one or more processors of the UE, may cause the UE to transmit or receive the reference signal based at least in part on a transmission frequency associated with the reference signal and the time-domain density configuration.

Some aspects described herein relate to an apparatus for wireless communication. The apparatus may include means for selecting a time-domain density configuration for a reference signal based at least in part on a transmission frequency associated with the reference signal. The apparatus may include means for transmitting an indication of the time-domain density configuration to a UE.

Some aspects described herein relate to an apparatus for wireless communication. The apparatus may include means for obtaining an indication of a time-domain density configuration associated with a reference signal. The apparatus may include means for transmitting or receiving the reference signal based at least in part on a transmission frequency associated with the reference signal and the time-domain density configuration.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

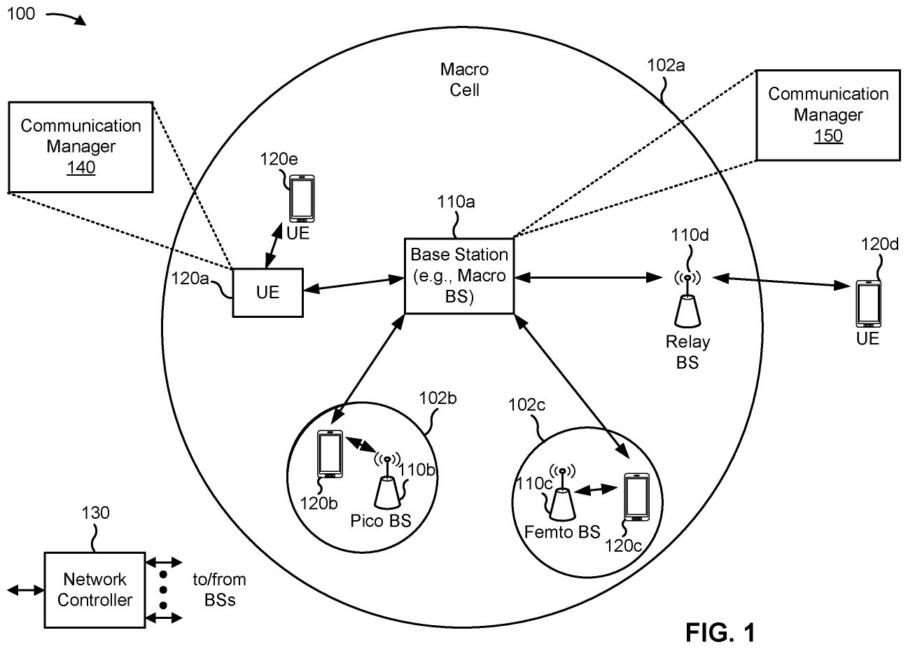

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), TRP, or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more distributed units (DUs), one or more radio units (RUs), or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5GNNR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the network entity may include a communication manager 150. As described in more detail elsewhere herein, the communication manager 150 may select a time-domain density configuration for a reference signal based at least in part on a transmission frequency associated with the reference signal; and transmit an indication of the time-domain density configuration to a UE. Additionally, or alternatively, the communication manager 150 may perform one or more other operations described herein.

In some aspects, the UE 120 may include a communication manager 140. As described in more detail elsewhere herein, the communication manager 140 may obtain an indication of a time-domain density configuration associated with a reference signal; and transmit or receive the reference signal based at least in part on a transmission frequency associated with the reference signal and the time-domain density configuration. Additionally, or alternatively, the communication manager 140 may perform one or more other operations described herein.

As indicated above, FIG. 1 is provided as an example. Other examples may differ from what is described with regard to FIG. 1.

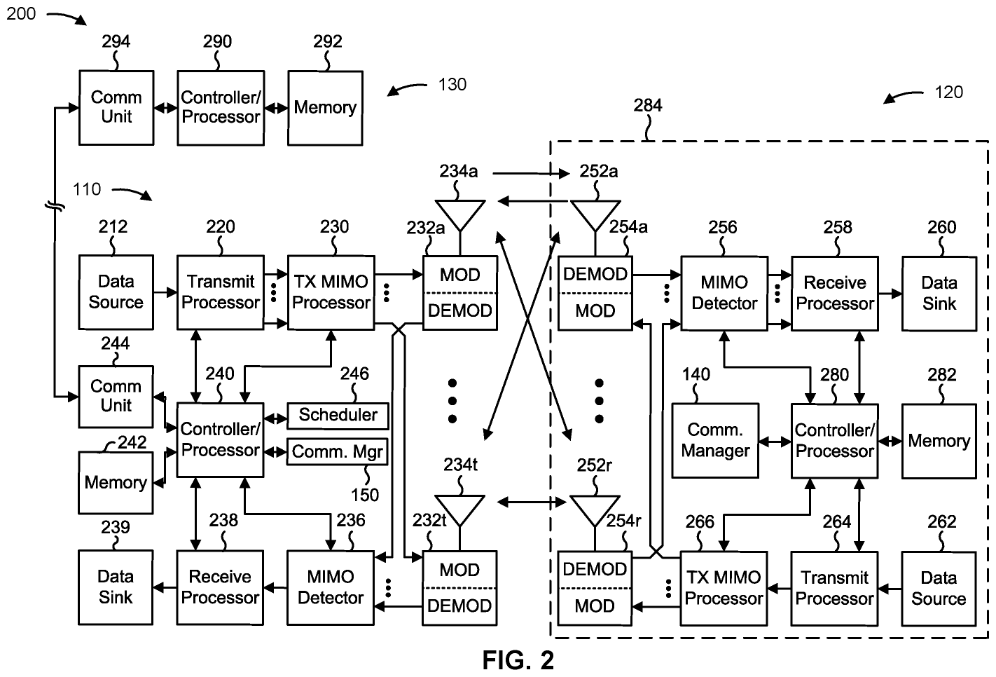

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

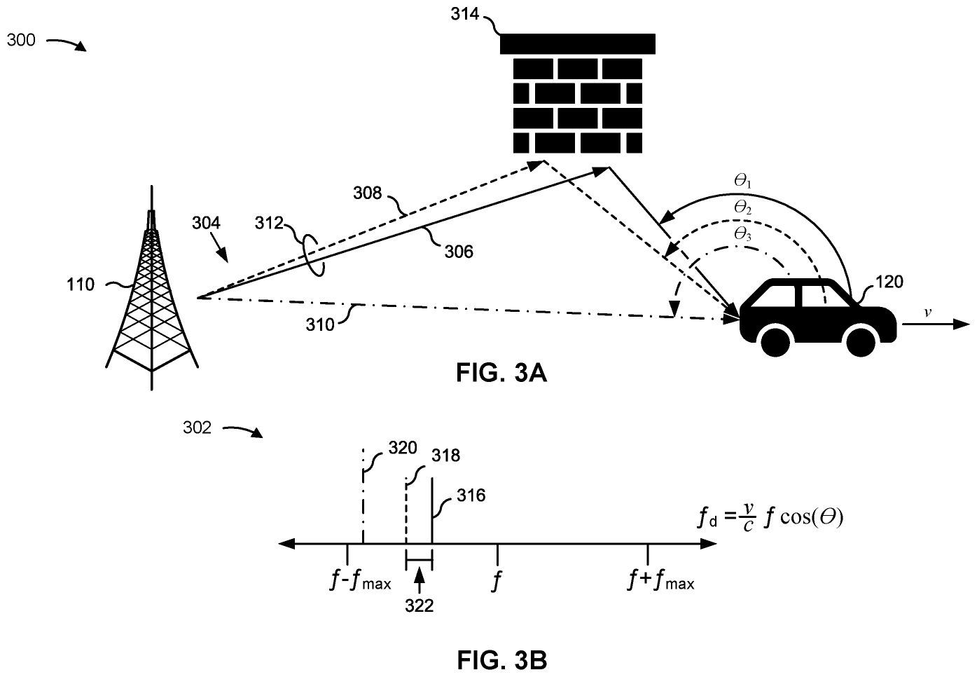

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3A-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3A-8).

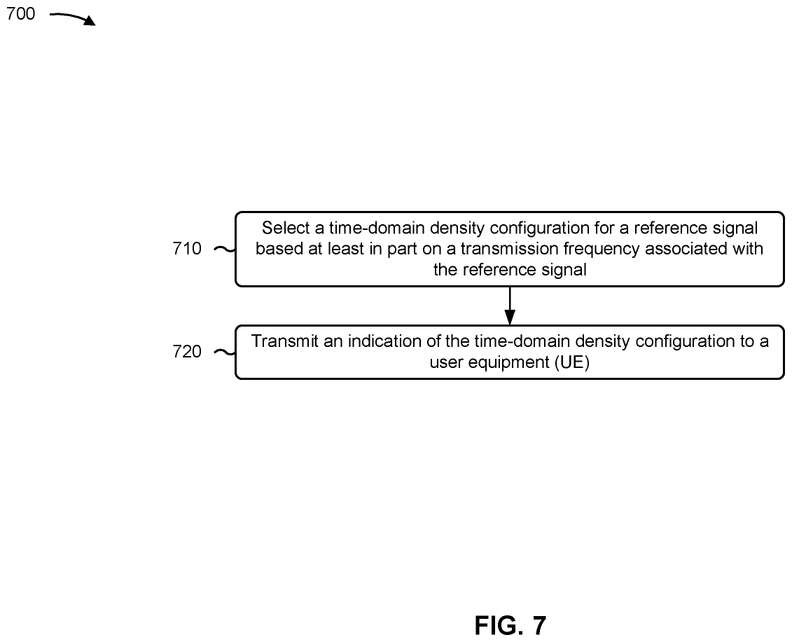

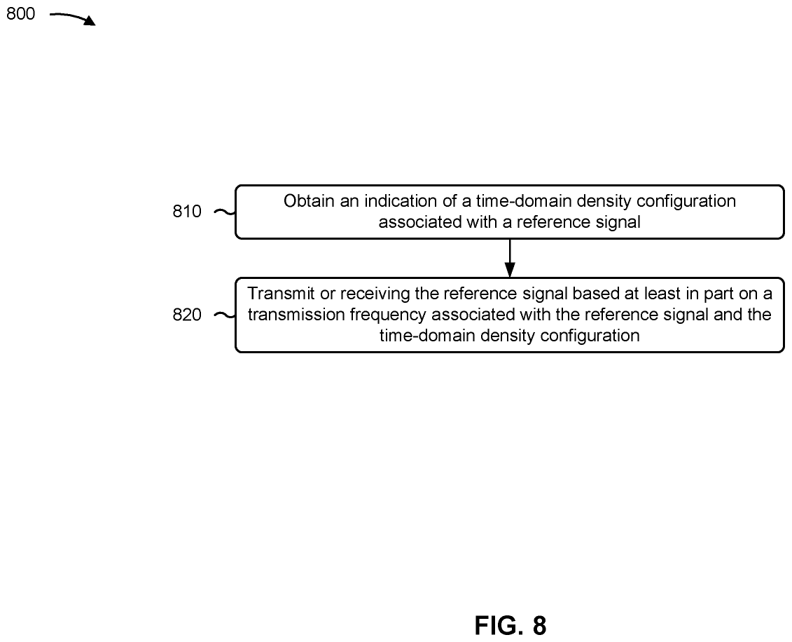

The controller/processor 240 of the base station 110, the controller/processor 280 of the UE 120, and/or any other component(s) of FIG. 2 may perform one or more techniques associated with adaptable time-domain density of a reference signal, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the network entity includes means for selecting a time-domain density configuration for a reference signal based at least in part on a transmission frequency associated with the reference signal; and/or means for transmitting an indication of the time-domain density configuration to a UE. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE includes means for obtaining an indication of a time-domain density configuration associated with a reference signal; and/or means for transmitting or receiving the reference signal based at least in part on a transmission frequency associated with the reference signal and the time-domain density configuration. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3A and FIG. 3B illustrate a first example 300 and a second example 302 of a Doppler spectrum, in accordance with the present disclosure.

In some aspects, Doppler effect and/or Doppler shift refers to a change in a signal transmitted between the devices based at least in part on movement of one or more devices. As one example, an observed frequency at a receiver may be different from a source frequency at a transmitter based at least in part on the transmitter moving, the receiver moving, and/or both the transmitter and the receiver moving. To illustrate, and as shown by the example 300, a stationary network entity (shown as a base station 110) may transmit a wireless signal 304 at a carrier frequency f_{c} to a non-stationary UE 120 (shown as a vehicle) moving with a velocity of v. The wireless signal 304 may include multiple rays, shown by the example 300 as a first ray 306, a second ray 308, and a third ray 310. A ray of a wireless signal may denote a signal that has energy and propagates through a medium in a straight line. Thus, the first ray 306, the second ray 308, and the third ray 310 may be considered different rays of the wireless signal 304 based at least in part on each ray propagating in different directions.

In some aspects, at least some of the rays of the wireless signal 304 may be grouped as a cluster of rays (cluster 312). A cluster of rays may denote a group of signal rays with commensurate delay. “Commensurate delay” may denote a first delay value that is within a threshold and/or within a range of values relative to a second delay value. For instance, as shown by the example 300, the cluster 312 may include the first ray 306 and the second ray 308 based at least in part on the first ray 306 and the second ray 308 of the wireless signal 304 having commensurate delay. The third ray 310 may be omitted from the cluster 312 based at least in part on the third ray 310 having a delay that is non-commensurate (e.g., outside of the threshold and/or outside the range) with the cluster 312.

In some aspects, each ray of the wireless signal 304 may strike an obstruction 314 and reflect off a surface of the obstruction 314 at different angles. To illustrate, the first ray 306 may strike the obstruction 314 at a first location and/or at a first incident angle, and the first ray 306 may reflect off the obstruction 314 at a first reflected angle. Based at least in part on each ray propagating in a different direction, the second ray 308 may strike the obstruction 314 at a second location and/or at a second incident angle and reflect off the obstruction 314 at a second reflected angle, where the first reflected angle is different from the second reflected angle. The third ray 310 may have a propagation path with a direct line-of-sight (LoS) to the UE 120 and avoid striking the obstruction 314. The non-stationary UE 120 may receive each ray at a different angle of arrival, shown in the example 300 as θ₁, θ₂, and θ₃. In some aspects and based at least in part on a movement of the non-stationary UE 120, the observed frequency of the first ray 306 (e.g., observed by the UE 120) may be different from the observed frequency of the ray 308 and/or the ray 310.

A Doppler spectrum may denote a range of Doppler frequencies for a source frequency (e.g., f_{c}) based at least in part on a velocity of a receiving device. In some aspects, a Doppler frequency (f_{d}) may be calculated based at least in part on the equation:

$${f}_{d} = \frac{v}{c} f cos θ \qquad ( 1 )$$

where v represents a velocity of the UE 120, c represents the speed of light, f represents a source frequency of a ray (e.g., the carrier frequency f_{c}), and θ represents an angle of arrival of the ray at the UE 120. In some aspects, a range associated with a Doppler spectrum and a value of fₘₐₓ may be based at least in part on the equation (1) and a maximum value of cos(θ). As shown by the example 302, the UE 120 may observe the first ray 306 at a first Doppler frequency 316, the second ray 308 at a second Doppler frequency 318, and the third ray 310 at a third Doppler frequency 320. Thus, the UE 120 may observe different Doppler frequencies for each ray in a cluster (e.g., the first ray 306 and the second ray 308), such as example difference 322.

As indicated above, FIGS. 3A and 3B are provided as an example. Other examples may differ from what is described with regard to FIGS. 3A and 3B.

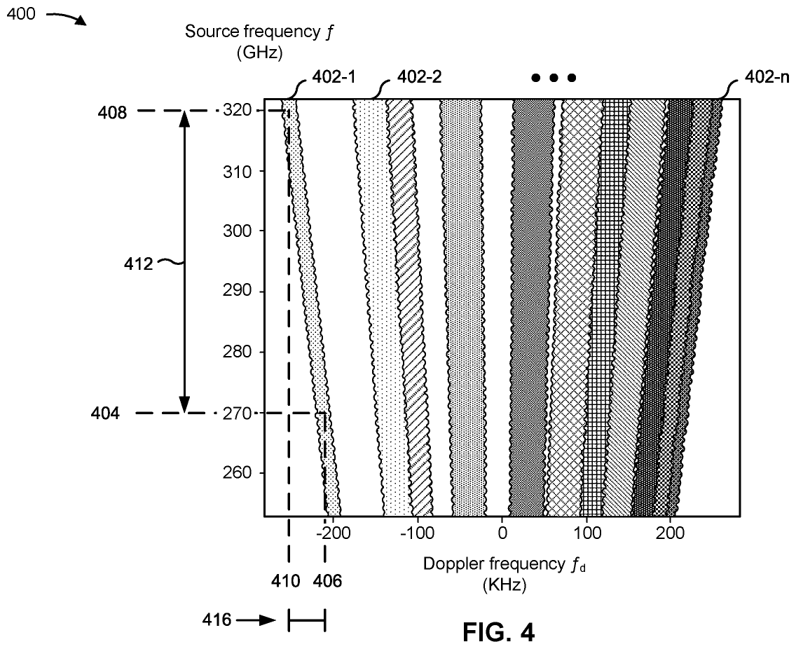

FIG. 4 illustrates an example 400 of Doppler squint, in accordance with the present disclosure.

A Doppler spectrum may be considered a range of Doppler frequencies that are based at least in part on a source frequency and/or a velocity of a receiver as further described with regard to FIGS. 3A and 3B. Thus, a non-stationary UE traveling at a velocity v may observe a first Doppler spectrum for a first source frequency and a second Doppler spectrum for a second source frequency. The difference in Doppler spectrums for different source frequencies may result in time sensitivity differences, which may also be referred to as Doppler squint as further described below.

The example 400 of FIG. 4 depicts a graph of various ray clusters and an observed Doppler spectrum at different source frequencies. A horizontal axis of the graph shown by the example 400 corresponds to a Doppler frequency in kilohertz (kHz) while a vertical axis of the graph corresponds to a source frequency in gigahertz (GHz). Each stripe within the graph represents a cluster of rays. The grouping of rays within a cluster may be based at least in part on one or more characteristics associated with the rays (e.g., a power level, a delay, and/or a spatial characteristic). The graph shown by the example 400 includes n clusters of rays, which are labeled as a first cluster of rays 402-1 (cluster 402-1), a second cluster of rays 402-2 (cluster 402-2), and so forth, up to an n^{th} cluster of rays 402-n (cluster 402-n), where n is an integer. The rays within each cluster may have commensurate delay.

A width of each cluster on the Doppler frequency axis may represent a range of frequencies associated with a Doppler spectrum for a particular source frequency. Thus, a cluster may have multiple Doppler spectrums based at least in part on the source frequency. To further illustrate, a first source frequency 404 may result in a first Doppler frequency 406 at a non-stationary UE (e.g., the UE 120) for a ray included in the cluster 402-1. A second source frequency 408 may result in a second Doppler frequency 410 at the non-stationary UE for the same ray in the cluster 402-1. Accordingly, for a same ray in a cluster, the difference in source frequencies as shown by reference number 412 may result in different Doppler frequencies (and different Doppler spectrums for the cluster) as shown by reference number 416. The Wiener-Khinchin theorem indicates that a time selectivity of a signal may be based at least in part on a Doppler spectrum associated with the signal. Consequently, different Doppler spectrums for the signal (e.g., at different source frequencies) may result in different time selectivity of the signal.

Time selectivity may denote amplitude variation of a communication channel and, subsequently, a signal propagating in the communication channel, in the time domain that may result in fading. To illustrate, rays of a wireless signal that propagate through the communication channel in different directions may destructively and/or constructively combine at a receiver and cause an amplitude variation in the time domain. In some aspects, the fading may apply to rays within a cluster.

For lower source frequencies and/or smaller frequency bands (e.g., source frequencies below 6 GHz and/or frequency bands less than 100 MHz), a difference in the time selectivity (e.g., Doppler squint) may be negligible. For example, the difference in time selectivity may be below a difference threshold that is associated with recovery errors. However, at higher source frequencies and/or larger frequency bands (e.g., source frequencies at or above 1 terahertz (THz) and/or frequency bands larger than 500 MHz), Doppler squint may cause inaccuracies that cause reduced performance (e.g., increased recovery errors, increased data transfer latencies, reduced data throughput) in a wireless communication system.

As one example, a network entity may transmit a reference signal and instruct a UE to calculate one or more signal metrics based at least in part on the reference signal (e.g., channel state information (CSI), channel estimation, a demodulation metric, and/or a carrier frequency offset (CFO) estimation). The network entity may transmit the reference signal based at least in part on a first source frequency in a lower frequency band (e.g., below 6 GHz) and a fixed time-domain density configuration, where a time-domain density of a signal may denote a number of communication resources that are used to transmit a signal, where the number of communication resources are based at least in part on a time unit (e.g., a symbol, a time slot, a mini-slot, and/or a time duration). A fixed time-domain density configuration may denote a static time-domain density configuration that may be applied for all transmission frequencies.

In some aspects, the fixed time-domain density may be inadequate for higher frequencies (e.g., above 6 GHz and/or above 1 THz). For example, the network entity may transmit the reference signal based at least in part on a second source frequency at a higher frequency using a same (fixed) time density that was used to transmit the reference signal at the first source frequency. Using the same (fixed) time density at the higher frequency may be inadequate based at least in part on Doppler squint and may result in errors at a receiving UE. To illustrate, the UE may calculate a CFO estimate based at least in part on a distorted signal (e.g., distortion due to fading), calculate a demodulation metric based at least in part on the distorted signal, and/or calculate CSI based at least in part on the distorted signal. The estimates and/or calculations based on the distorted signal may result in the UE failing to demodulate a signal properly, failing to recover information properly, and/or providing the network entity with inaccurate CSI. Alternatively or additionally, the estimates on the distorted signal may cause the network entity to select an MCS and/or communication resource (e.g., a bandwidth part (BWP), a physical resource block (PRB), a sub-band, a beam, a symbol, a time slot, a mini-slot, and/or a time duration) that results in reduced performance (e.g., increased recovery errors, increased data transfer latencies, reduced data throughput) at the UE.

Some techniques and apparatuses described herein provide adaptable time-domain density of a reference signal. In some aspects, a network entity may select a time-domain density configuration for a reference signal based at least in part on a transmission frequency associated with the reference signal. To illustrate, the network entity may select a first time-domain density configuration associated with transmitting the reference signal based at least in part on a first transmission frequency and a second time-domain density configuration associated with transmitting the reference signal based at least in part on a second transmission frequency that is different from the first transmission frequency. The network entity may then transmit an indication of the time-domain density configuration to a UE. The network entity may transmit time-domain density information that indicates one or more time-domain density configurations.

In some aspects, a UE may obtain an indication of a time-domain density configuration associated with a reference signal. To illustrate, the UE may receive the indication from a network entity (e.g., an index into a look up table and/or an index associated with a set of time-domain density configurations). As another example, the UE may obtain a time-domain density configuration based at least in part on one or more pre-configured time-domain density configurations (e.g., stored in memory at the UE). Based at least in part on obtaining the time-domain density configuration, the UE may transmit the reference signal based at least in part on a transmission frequency associated with the reference signal and the time-domain density configuration.

Using different time-domain densities for a reference signal based at least in part on a transmission frequency of the reference signal may reduce distortions in the received reference signal that are introduced based at least in part on Doppler squint. Reducing distortion may improve performance in a wireless network by improving an accuracy of signal metric calculations (e.g., a demodulation metric, CFO, and/or CSI). The improved accuracy may result in the network entity selecting an MCS and/or communication resource that improves performance (e.g., reduced recovery errors, reduced data transfer latencies, increased data throughput) at the UE relative to using a fixed time-domain density for the reference signal at all transmission frequencies.

As indicated above, FIG. 4 is provided as an example. Other examples may differ from what is described with regard to FIG. 4.

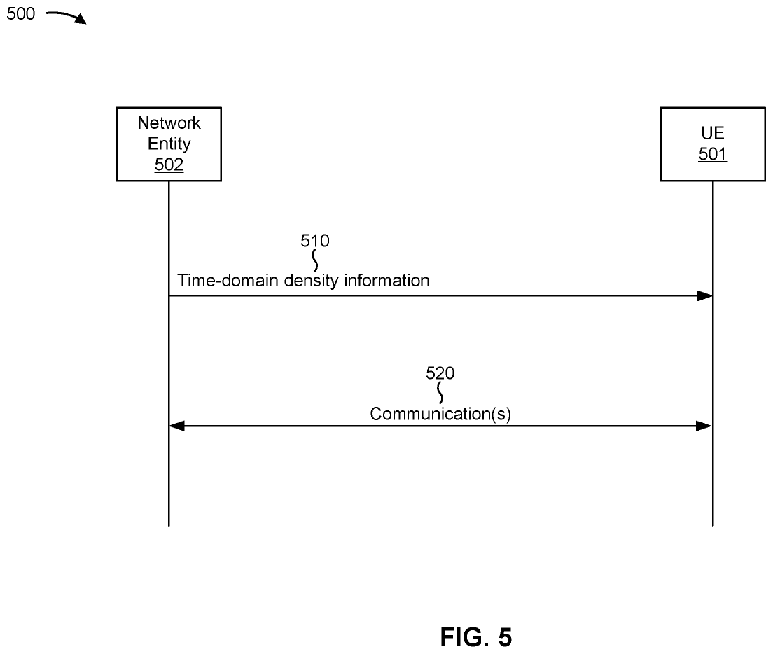

FIG. 5 illustrates an example 500 of a wireless communication process between a UE 501 (e.g., a UE 120 or an apparatus 1000) and a network entity 502 (e.g., a base station 110 or an apparatus 900) in a wireless communication network, in accordance with the present disclosure.

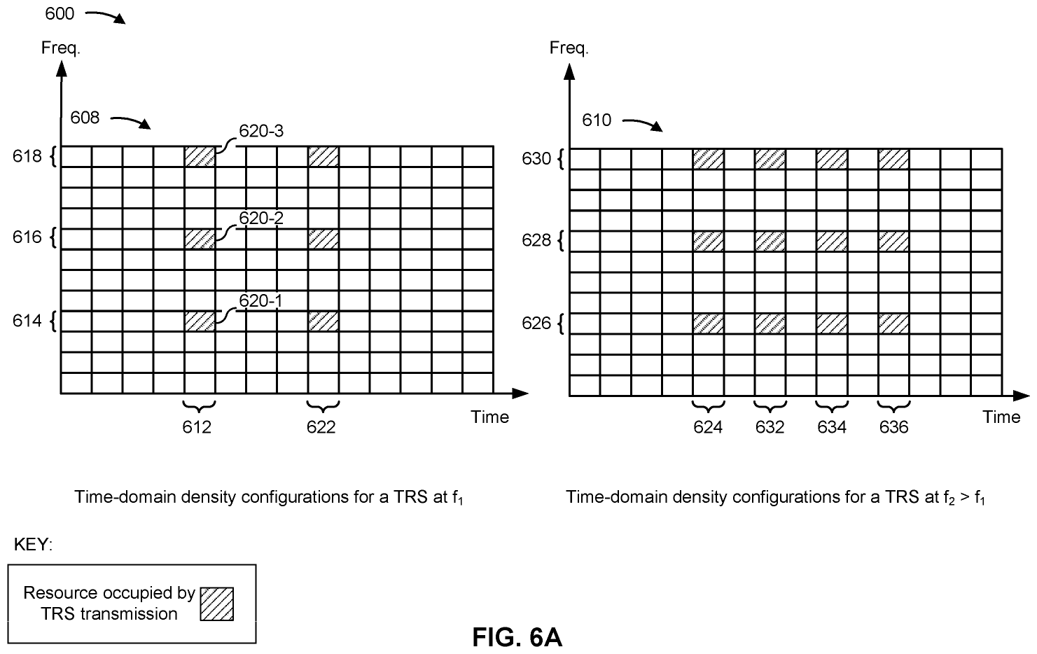

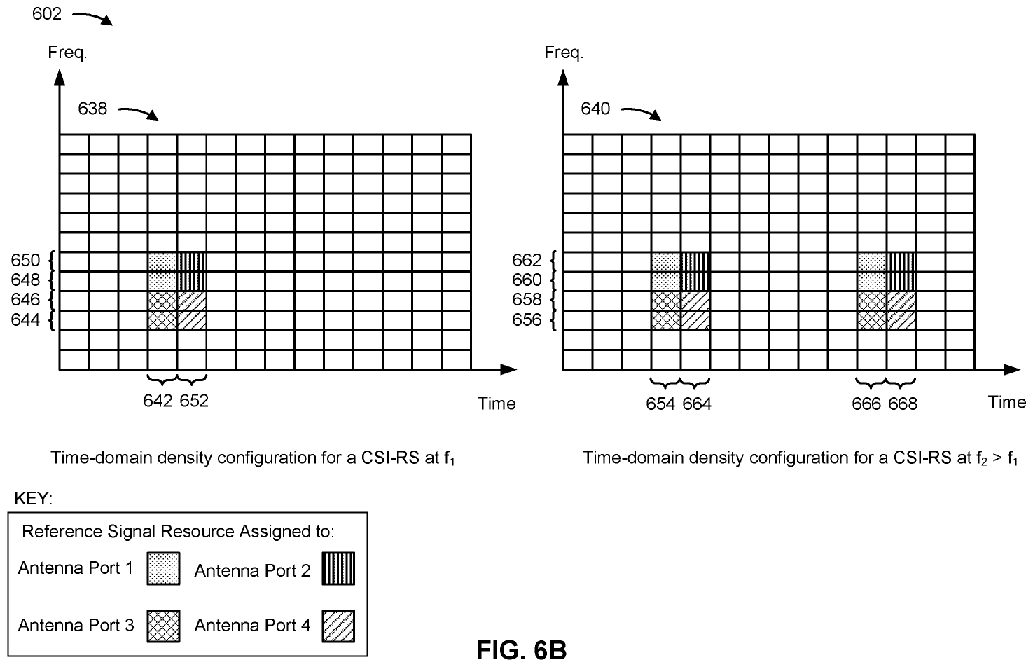

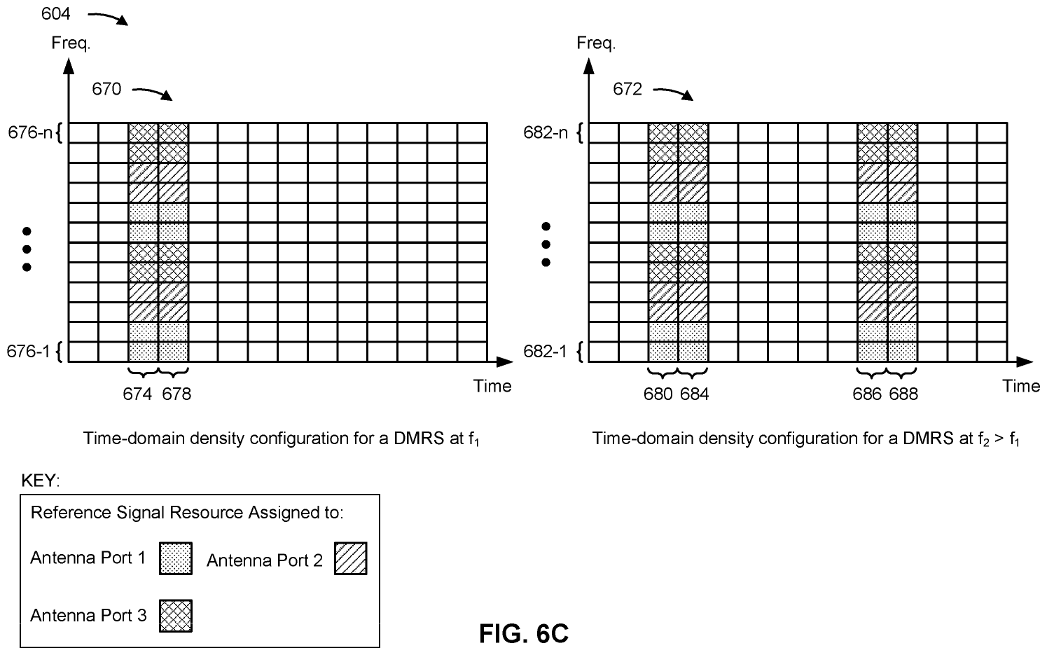

As shown by reference number 510, the network entity 502 may transmit, and the UE 501 may receive, time-domain density information. As one example, the network entity 502 may transmit the time-domain density information to the UE 501 as a broadcast message, a unicast message, or a multi-cast message. Alternatively or additionally, the network entity 502 may transmit the time-domain density information based at least in part on a low band connection (e.g., under 6 GHz), where the time-domain density information indicates a time-domain density configuration associated with a transmission frequency above the low band (e.g., above 6 GHz). In some aspects, the time-domain density information indicates one or more time-domain density configurations as further described with regard to FIGS. 6-8. In some aspects, the network entity 502 may transmit the time-domain density information using multiple transmissions or in an iterative manner. While the example 500 shows the network entity 502 transmitting the time-domain density information to the UE 501, other examples may include the network entity 502 and the UE 501 using pre-configured (e.g., a common definition shared between the network entity and the UE) time-domain density information. As one example of pre-configured time-domain density information, the UE 501 and/or the network entity 502 may obtain time-domain density information that may be stored in memory at the device, stored in a file at the device, and/or fixed in programming at the device. The pre-configured time-domain density information may include one or more pre-configured time-domain density configurations, where each pre-configured time-domain density configuration associated with a reference signal may be based at least in part on a different transmission frequency relative to other pre-configured time-domain density configurations associated with the reference signal.

In some aspects, a time-domain density configuration indicated by the time-domain density information may be associated with a reference signal, such as a CSI reference signal (CSI-RS), a tracking reference signal (TRS), a downlink DMRS associated with the network entity 502, and/or an uplink DMRS associated with the UE 501. Alternatively or additionally, the network entity 502 may instruct the UE 501 (e.g., at a later point in time) to calculate one or more signal metrics based at least in part on the CSI-RS, where the one or more signal metrics characterize a communication channel between the network entity and the UE. The network entity 502 may configure communications with the UE based at least in part on the one or more signal metrics (and/or the channel characterization), such as by selecting an MCS and/or a communication resource based at least in part on the signal metric(s). A communication resource may be characterized by a frequency unit and/or a time unit, such as a BWP, a PRB, a sub-band, a beam, a symbol, a time slot, a mini-slot, and/or a time duration. As another example, the network entity may transmit, and the UE may receive, a TRS that enables the UE and/or the network entity to compensate for oscillator differences between the devices (e.g., to align and/or calibrate signal timing). A downlink and/or uplink DMRS may provide a receiving device (e.g., the UE or the network entity) with an ability to calculate one or more signal metrics associated with initial estimates of channel properties between the devices and, subsequently, demodulate a signal transmitted between the devices. Thus, the network entity 502 may indicate, in the time-domain density information, a time-domain density configuration associated with a CSI-RS, a TRS, a downlink DMRS, and/or an uplink DMRS.

A time-domain density configuration may indicate a time configuration associated with transmitting a signal (e.g., a reference signal), such as a number of time-domain resources (e.g., a number of symbols, a number of slots, a number of mini-slots, and/or a time duration) associated with transmitting the signal. In some aspects, a time-domain density configuration may also indicate one or more frequency units and/or resources associated with the time-domain resources. To illustrate, and as further described with regard to FIGS. 6A-6C, a reference signal may have a time-domain density configuration that is based at least in part on one or more time units (e.g., a symbol, a time slot, a mini-slot, and/or a time duration), one or more frequency resource units (e.g., a symbol, a PRB, a BWP, a sub-band, a mini-slot, and/or a frequency band), and/or one or more antenna ports.

The network entity 502 may indicate a time-domain density configuration that is based at least in part on a transmission frequency. For example, the network entity 502 may transmit a first time-domain density configuration associated with transmitting a reference signal at a first transmission frequency and a second time-domain density configuration associated with transmitting the reference signal at a second transmission frequency, where the second transmission frequency is higher than the first transmission frequency. Based at least in part on the second transmission frequency being higher than the first transmission frequency, the second time-domain density configuration may indicate a higher time-domain density relative to the first time-domain density configuration. To illustrate, the first time-domain density configuration may indicate and/or be based at least in part on a first number of time-domain units and the second time-domain density configuration may indicate and/or be based at least in part on a second number of time-domain units. The second time-domain density configuration may have a higher time-domain density relative to the first time-domain density configuration based at least in part on the second number of time-domain units being larger than the first number of time-domain units. The network entity 502 may transmit the first time-domain density configuration in a same transmission as the second time-domain density configuration, or different transmissions.

As shown by reference number 520, the network entity 502 and the UE 501 may communicate with one another based at least in part on the time-domain density information. As one example, the network entity 502 may transmit, and the UE 501 may receive, a reference signal based at least in part on a time-domain density configuration and/or a transmission frequency. For example, the network entity 502 may transmit a CSI-RS, a TRS, and/or a downlink DMRS at a first transmission frequency and based at least in part on a first number of time-domain units indicated by a first time-domain density configuration. In some aspects, the network entity 502 may dynamically modify a time-domain density associated with the reference signal. To illustrate, the network entity 502 may transmit the reference signal at a second transmission frequency that is higher than the first transmission frequency and with a second time-domain density configuration that includes more time-domain units relative to the first time-domain density configuration.

As another example, the UE 501 may transmit, and the network entity 502 may receive, an uplink DMRS at a first transmission frequency and based at least in part on a first time-domain density configuration that is based at least in part on a first number of time-domain units (e.g., a symbol, a slot, a mini-slot, and/or a time duration). In a similar manner as the network entity 502, the UE 501 may dynamically modify a time-domain density associated with the reference signal by transmitting the reference signal at a second transmission frequency that is higher than the first transmission frequency and with more time-domain units relative to the first time-domain density configuration.

Using different time-domain densities for a reference signal based at least in part on a transmission frequency of the reference signal may reduce distortions in the received reference signal that are introduced based at least in part on Doppler squint. Reduced distortion in a reference signal may improve performance in a wireless network by improving an accuracy of signal metric calculations. The improved accuracy may result in the network entity selecting communication configurations that reduce recovery errors, reduce data transfer latencies, and/or increase data throughput in the wireless network relative to using a fixed time-domain density for the reference signal at all transmission frequencies.

As indicated above, FIG. 5 is provided as an example. Other examples may differ from what is described with regard to FIG. 5.

FIGS. 6A, 6B, and 6C illustrate, respectively, a first example 600, a second example 602, and a third example 604 of different time-domain density configurations for a reference signal, in accordance with the present disclosure.

The first example 600 illustrates a first time-domain density configuration 608 associated with transmitting a TRS at a first transmission frequency f₁ and a second time-domain density configuration 610 associated with transmitting the TRS at a second transmission frequency f₂. A horizontal axis of each time-domain density configuration represents time and a vertical axis of each time-domain density configuration represents frequency. Each time-domain density configuration has been partitioned in time and frequency such that each rectangle within the time-domain density configuration may represent a resource (e.g., a communication resource) characterized at least in part by a time unit (e.g., a symbol, a time slot, a mini-slot, and/or a time duration) and a frequency unit (e.g., a BWP, a PRB, a sub-band, and/or a beam).

In some aspects, a time-domain density configuration may denote one or more resources associated with transmitting a signal, such as a reference signal. To illustrate, the first time-domain density configuration 608 may be based at least in part on transmitting a signal at a first time unit 612 and three frequency units (e.g., a first frequency unit 614, a second frequency unit 616, and a third frequency unit 618). Thus, the first time-domain density configuration 608 may be based at least in part on transmitting a signal at a first resource 620-1, a second resource 620-2, and a third resource 620-3, where the resources may be defined by the first time unit 612, the first frequency unit 614, the second frequency unit 616, and the third frequency unit 618. Alternatively or additionally, the first time-domain density configuration 608 may be based at least in part on transmitting a signal at a second time unit 622 and the three frequency units (e.g., the first frequency unit 614, the second frequency unit 616, and the third frequency unit 618). Resources occupied and/or associated with the first time-domain density configuration 608 are denoted with a diagonal hash pattern. Accordingly, a device transmitting a TRS based at least in part on the first transmission frequency f₁ may transmit the TRS based at least in part on the first time-domain density configuration 608.

The device may alternatively or additionally be configured to transmit the TRS based at least in part on the second time-domain density configuration 610. As one example, the device may dynamically switch from the first time-domain density configuration 608 to the second time-domain density configuration 610 for transmitting the TRS based at least in part on the second transmission frequency f₂. Similar to the first time-domain density configuration 608, the second time-domain density configuration 610 may be based at least in part on transmitting a signal in resources defined by one or more time units and one or more frequency units. Based at least in part on the second transmission frequency f₂ being at a higher frequency relative to the first transmission frequency transmission frequency f₁, the second time-domain density configuration 610 may have a higher time domain density relative to the first time-domain density configuration 608. To illustrate, the second time-domain density configuration 610 may indicate to transmit the TRS based at least in part on three resources defined by a first time unit 624 and three frequency units 626, 628, and 630. The three frequency units 626, 628, and 630 may be the same frequency units as the frequency units 614, 616, and 618, or different frequency units. Similarly, the first time unit 624 may be a same time unit as the time unit 612 or a different time unit. The second time-domain density configuration 610 may include transmissions in additional resources defined by a second time unit 632 and the three frequency units 626, 628, and 630, a third time unit 634 and the three frequency units 626, 628, and 630, and a fourth time unit 636 and the three frequency units 626, 628, and 630. Accordingly, the second time-domain density configuration 610 indicates to transmit the TRS based at least in part on more time-domain units relative to the first time-domain density configuration 608. Resources occupied and/or associated with the second time-domain density configuration 610 are denoted with a diagonal hash pattern.

The second example 602 illustrates a first time-domain density configuration 638 associated with transmitting a CSI-RS at a first transmission frequency f₁ and a second time-domain density configuration 640 associated with transmitting the CSI-RS at a second transmission frequency f₂. Similar to that described with regard to the example 600, a horizontal axis of each time-domain density configuration represents time, and a vertical axis of each time-domain density configuration represents frequency. Each rectangle within the time-domain density configuration may represent a resource that may be characterized by a time unit and a frequency unit.

A device configured to transmit a CSI-RS at the first transmission frequency f₁ may transmit the CSI-RS based at least in part on the first time-domain density configuration 638. To illustrate, the first time-domain density configuration 638 may indicate to transmit the CSI-RS based at least in part on one or more resources defined by a first time unit 642 and four frequency units (e.g., a first frequency unit 644, a second frequency unit 646, a third frequency unit 648, and a fourth frequency unit 650). Alternatively or additionally, the first time-domain density configuration 638 may indicate to transmit the CSI-RS based at least in part on one or more resources defined by a second time unit 652 and the four frequency units 644, 646, 648, and 650. In some aspects, the first time-domain density configuration 638 may indicate to transmit the different CSI-RS ports with different resources, such as transmitting one or more first resources (indicated through the use of a dotted hash pattern) based at least in part on a first CSI-RS port, one or more second resources (indicated through the use of a cross line hash pattern) based at least in part on a second CSI-RS port, one or more third resources (indicated through the use of a vertical line hash pattern) based at least in part on a third CSI-RS port, and/or one or more fourth resources (indicated through the use of a diagonal hash pattern) based at least in part on a fourth CSI-RS port. In some aspects, multiple CSI-RS ports may transmit a same resource using different code division multiplexing (CDM) codewords in the frequency domain.

The device may alternatively or additionally be configured to transmit the CSI-RS based at least in part on the second time-domain density configuration 640. As one example, the device may dynamically switch from the first time-domain density configuration 638 to the second time-domain density configuration 640 for transmitting the CSI-RS based at least in part on the second transmission frequency f₂. Similar to the first time-domain density configuration 638, the second time-domain density configuration 640 may indicate to transmit the CSI-RS based at least in part on one or more resources defined by a first time unit 654 and four frequency units (e.g., a first frequency unit 656, a second frequency unit 658, a third frequency unit 660, and a fourth frequency unit 662). Alternatively or additionally, the second time-domain density configuration 640 may indicate to transmit the CSI-RS based at least in part on one or more resources a defined by a second time unit 664, a third time unit 666, a fourth time unit 668 and the four frequency units 656, 658, 660, and 662.

The resources in the second time-domain density configuration 640 may be based at least in part on time units and/or frequency units that are the same as the time units and/or frequency units associated with the first time-domain density configuration 638. Other examples may include the second time-domain density configuration 640 being based at least in part on time units and/or frequency units that are different from the time units and/or frequency units associated with the first time-domain density configuration 638. A number of time units associated with the second time-domain density configuration 640 may be larger than a number of time units associated with the first time-domain density configuration 638 based at least in part on the second time-domain density configuration 640 being associated with a higher transmission frequency.

In some aspects, the second time-domain density configuration 640 may indicate to transmit the different CSI-RS ports with different resources. For example, the second time-domain density configuration 640 may indicate to transmit the different CSI-RS ports with different resources based at least in part on the first resources, the second resources, the third resources, and/or the fourth resources.

The third example 604 illustrates a first time-domain density configuration 670 associated with transmitting a DMRS at a first transmission frequency f₁ and a second time-domain density configuration 672 associated with transmitting the DMRS at a second transmission frequency f₂ that is higher than the first transmission frequency f₁. Similar to that described with regard to the example 600 and the example 602, a horizontal axis of each time-domain density configuration represents time and a vertical axis of each time-domain density configuration represents frequency. Each rectangle within the time-domain density configuration may represent a resource that may be characterized at least in part by a time unit and a frequency unit.

A device configured to transmit a DMRS at a frequency associated with the first transmission frequency f₁ may transmit the DMRS based at least in part on the first time-domain density configuration 670. To illustrate, the first time-domain density configuration 670 may indicate to transmit the DMRS based at least in part on one or more resources defined by a first time unit 674 and a range of frequency units (shown in the example 604 as frequency unit 676-1 to frequency unit 676-n, where n is an integer). Alternatively or additionally, the first time-domain density configuration 670 may indicate to transmit the DMRS based at least in part on one or more resources defined by a second time unit 678 and the range of frequency units. Similar to that described with regard to the example 602, the first time-domain density configuration 670 may indicate to transmit the different DMRS ports with different resources, such as one or more first resources associated with a first antenna port (indicated through the use of a dotted hash pattern), one or more second resources associated with a second antenna port (indicated through the use of a cross line hash pattern), and/or one or more third resources associated with a third antenna port (indicated through the use of a diagonal line hash pattern).

The device may alternatively or additionally be configured to transmit the DMRS based at least in part on the second time-domain density configuration 672. As one example, the device may dynamically switch from the first time-domain density configuration 670 to the second time-domain density configuration 672 for transmitting the DMRS based at least in part on the second transmission frequency f₂. Similar to the first time-domain density configuration 670, the second time-domain density configuration 672 may indicate to transmit the DMRS based at least in part on one or more resources defined by a first time unit 680 and a range of frequency units (shown in the example 604 as frequency unit 682-1 to frequency unit 682-n, where n is an integer). Alternatively or additionally, the second time-domain density configuration 672 may indicate to transmit the DMRS based at least in part on one or more resources defined by a second time unit 684, a third time unit 686, a fourth time unit 688, and the range of frequency units 682-1 to 682-n. The resources in the second time-domain density configuration 672 may be based at least in part on time units and/or frequency units that are the same as the time units and/or frequency units that define the first time-domain density configuration 670. Other examples may include the second time-domain density configuration 672 being based at least in part on time units and/or frequency units that are different from the time units and/or frequency units associated with the first time-domain density configuration 670. A number of time units associated with the second time-domain density configuration 672 may be larger than a number of time units associated with the first time-domain density configuration 670 based at least in part on the second time-domain density configuration 672 being associated with a higher transmission frequency.

In some aspects, the second time-domain density configuration 672 may indicate to transmit the different DMRS ports (e.g., antenna ports) with different resources. For example, and in a similar manner as described with regard to FIG. 6B, the second time-domain density configuration 672 may indicate to transmit the different DMRS ports with different resources based at least in part on the first resources, the second resources, and/or the third resources.

Dynamically switching between time-domain densities for a reference signal based at least in part on a transmission frequency may reduce distortions in a received reference signal that are introduced based at least in part on Doppler squint. Reduced distortion in the reference signal may improve performance in a wireless network by improving an accuracy of signal metric calculations. The improved accuracy may result in communication configurations that reduce recovery errors, reduce data transfer latencies, and/or increase data throughput in the wireless network relative to using a fixed time-domain density for the reference signal at all transmission frequencies.

As indicated above, FIGS. 6A, 6B, and 6C are provided as an example. Other examples may differ from what is described with regard to FIGS. 6A, 6B, and 6C.

FIG. 7 is a diagram illustrating an example process 700 performed, for example, by a network entity, in accordance with the present disclosure. Example process 700 is an example where the network entity (e.g., a base station 110 or an apparatus 900) performs operations associated with adaptable time-domain density of a reference signal.

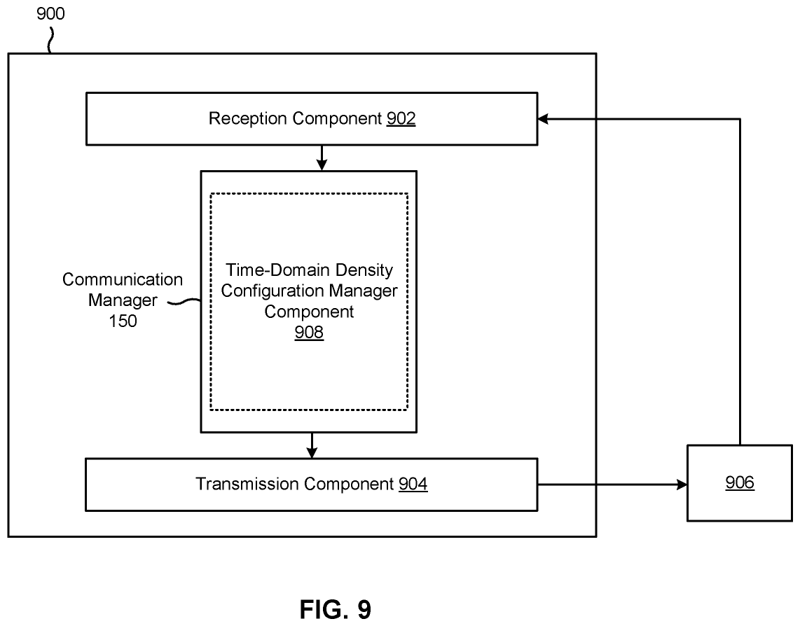

As shown in FIG. 7, in some aspects, process 700 may include selecting a time-domain density configuration for a reference signal based at least in part on a transmission frequency associated with the reference signal (block 710). For example, the network entity (e.g., using communication manager 150 and/or time-domain density configuration manager component 908, depicted in FIG. 9) may select a time-domain density configuration for a reference signal based at least in part on a transmission frequency associated with the reference signal, as described above.

As further shown in FIG. 7, in some aspects, process 700 may include transmitting an indication of the time-domain density configuration to a UE (block 720). For example, the network entity (e.g., using communication manager 150 and/or transmission component 904, depicted in FIG. 9) may transmit an indication of the time-domain density configuration to a UE, as described above.

Process 700 may include additional aspects, such as any single aspect or any combination of aspects described below and/or in connection with one or more other processes described elsewhere herein.

In a first aspect, the transmission frequency is a first transmission frequency, wherein the time-domain density configuration is a first time-domain density configuration, wherein the indication is a first indication, and the process 700 further comprises selecting a second time-domain density configuration for the reference signal based at least in part on a second transmission frequency associated with the reference signal, and transmitting an indication of the second time-domain density configuration to the UE, wherein the first transmission frequency is different from the second transmission frequency.

In a second aspect, alone or in combination with the first aspect, at least one of the first time-domain density configuration or the second time-domain density configuration indicates an antenna port associated with transmitting the reference signal.

In a third aspect, alone or in combination with one or more of the first and second aspects, the second transmission frequency is higher than the first transmission frequency, the first time-domain density configuration is based at least in part on a first number of time units, wherein the second time-domain density configuration is based at least in part on a second number of time units, and wherein the second number is larger than the first number.

In a fourth aspect, alone or in combination with one or more of the first through third aspects, a time unit is at least one of a symbol, a time slot, a mini-slot, or a time duration.

In a fifth aspect, alone or in combination with one or more of the first through fourth aspects, the time-domain density configuration indicates a time-domain density that is based at least in part on a frequency unit of at least one of a BWP, a sub-band, or a PRB.

In a sixth aspect, alone or in combination with one or more of the first through fifth aspects, the reference signal is a CSI-RS, a TRS, a DMRS, or an uplink DMRS.

In a seventh aspect, alone or in combination with one or more of the first through sixth aspects, process 700 includes transmitting or receiving the reference signal based at least in part on the time-domain density configuration and/or a transmission frequency associated with the reference signal.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., a UE 120 or an apparatus 1000) performs operations associated with adaptable time-domain density of a reference signal.

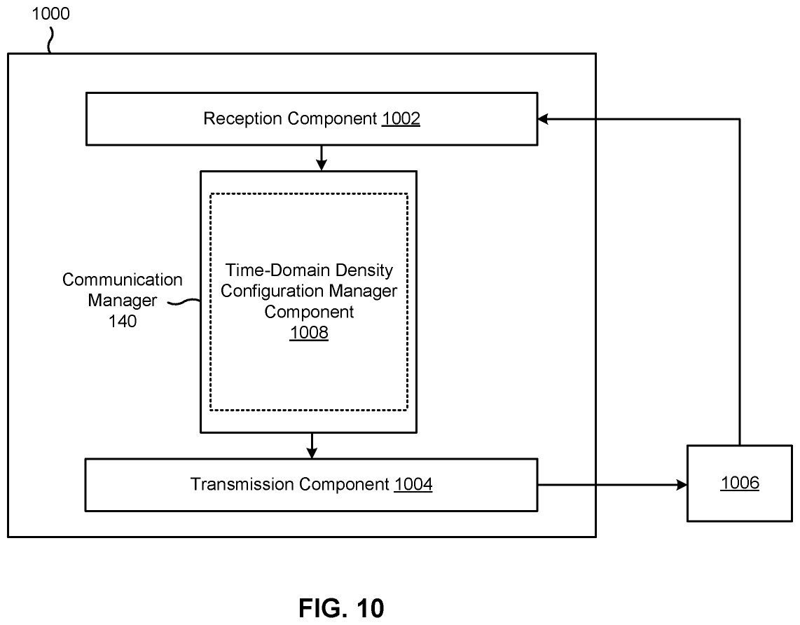

As shown in FIG. 8, in some aspects, process 800 may include obtaining an indication of a time-domain density configuration associated with a reference signal (block 810). For example, the UE (e.g., using communication manager 140, reception component 1002, and/or time-domain density configuration manager component 1008 component, depicted in FIG. 10) may obtain an indication of a time-domain density configuration associated with a reference signal from a network entity or from memory, as described above.

As further shown in FIG. 8, in some aspects, process 800 may include transmitting or receiving the reference signal based at least in part on a transmission frequency associated with the reference signal and the time-domain density configuration (block 820). For example, the UE (e.g., using communication manager 140 and/or transmission component 1004, depicted in FIG. 10) may transmit or receive the reference signal based at least in part on a transmission frequency associated with the reference signal and the time-domain density configuration, as described above.

Process 800 may include additional aspects, such as any single aspect or any combination of aspects described below and/or in connection with one or more other processes described elsewhere herein.

In a first aspect, the transmission frequency is a first transmission frequency, wherein the time-domain density configuration is a first time-domain density configuration, wherein the indication is a first indication, and the process 800 further comprises obtaining a second time-domain density configuration for the reference signal based at least in part on a second transmission frequency associated with the reference signal, wherein the first transmission frequency is different from the second transmission frequency.

In a second aspect, alone or in combination with the first aspect, at least one of the first time-domain density configuration or the second time-domain density configuration indicates an antenna port associated with transmitting the reference signal.

In a third aspect, alone or in combination with one or more of the first and second aspects, the second transmission frequency is higher than the first transmission frequency, the first time-domain density configuration is based at least in part on a first number of time units, wherein the second time-domain density configuration is based at least in part on a second number of time units, and wherein the second number is larger than the first number.

In a fourth aspect, alone or in combination with one or more of the first through third aspects, a time unit is at least one of a symbol, a time slot, a mini-slot, or a time duration.

In a fifth aspect, alone or in combination with one or more of the first through fourth aspects, the time-domain density configuration indicates a time-domain density that is based at least in part on a frequency unit of at least one of a BWP, a sub-band, or a PRB.

In a sixth aspect, alone or in combination with one or more of the first through fifth aspects, the reference signal is a CSI-RS, a TRS, a downlink DMRS, or an uplink DMRS.

In a seventh aspect, alone or in combination with one or more of the first through sixth aspects, obtaining the indication of the time-domain density configuration further comprises receiving the indication of the time-domain density configuration from a network entity, or obtaining a pre-configured time-domain density configuration.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a network entity, or a network entity may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include one or more of a time-domain density configuration manager component 908, among other examples.

In some aspects, the apparatus 900 may be configured to perform one or more operations described herein in connection with FIGS. 3A-8. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network entity described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network entity described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network entity described in connection with FIG. 2. In some aspects, the transmission component 904 may be co-located with the reception component 902 in a transceiver.

The time-domain density configuration manager component 908 may select a time-domain density configuration for a reference signal based at least in part on a transmission frequency associated with the reference signal. The transmission component 904 may transmit an indication of the time-domain density configuration to a UE.

The transmission component 904 may transmit the reference signal (e.g., a downlink DMRS, a CSI-RS, and/or a TRS) based at least in part on the time-domain density configuration and a transmission frequency associated with the reference signal. Alternately or additionally, the reception component 902 may receive the reference signal (e.g., an uplink DMRS) based at least in part on the time-domain density configuration and a transmission frequency associated with the reference signal.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of a time-domain density configuration manager component 1008, among other examples.

In some aspects, the apparatus 1000 may be configured to perform one or more operations described herein in connection with FIGS. 3A-8. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The time-domain density configuration manager component 1008 may obtain an indication of a time-domain density configuration associated with a reference signal. As one example, the time-domain density configuration manager component 1008 may receive the time-domain density configuration from a network entity and based at least in part on the reception component 1002. As another example, the time-domain density configuration manager component 1008 may obtain the time-domain density configuration from pre-configured time-domain density information (e.g., one or more time-domain density configurations) stored in memory of the apparatus 1000.

The transmission component 1004 may transmit the reference signal (e.g., an uplink DMRS) based at least in part on a transmission frequency associated with the reference signal and the time-domain density configuration. Alternatively or additionally, the reception component 1002 may receive the reference signal (e.g., a downlink DMRS, a CSI-RS, and/or a TRS) based at least in part on a transmission frequency associated with the reference signal and the time-domain density configuration.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

Aspect 1: A method of wireless communication performed by a network entity, comprising: selecting a time-domain density configuration for a reference signal based at least in part on a transmission frequency associated with the reference signal; and transmitting an indication of the time-domain density configuration to a user equipment (UE).

Aspect 2: The method of Aspect 1, wherein the transmission frequency is a first transmission frequency, wherein the time-domain density configuration is a first time-domain density configuration, wherein the indication is a first indication, and the method further comprises: selecting a second time-domain density configuration for the reference signal based at least in part on a second transmission frequency associated with the reference signal, and transmitting an indication of the second time-domain density configuration to the UE, wherein the first transmission frequency is different from the second transmission frequency.

Aspect 3: The method of Aspect 2, wherein at least one of the first time-domain density configuration or the second time-domain density configuration indicate an antenna port associated with transmitting the reference signal.

Aspect 4: The method of Aspect 2 or Aspect 3, wherein the second transmission frequency is higher than the first transmission frequency, wherein the first time-domain density configuration is based at least in part on a first number of time units, wherein the second time-domain density configuration is based at least in part on a second number of time units, and wherein the second number is larger than the first number.

Aspect 5: The method of Aspect 4, wherein a time unit is at least one of: a symbol, a time slot, a mini-slot, or a time duration.

Aspect 6: The method of any one of Aspects 1-5, wherein the time-domain density configuration indicates a time-domain density that is based at least in part on a frequency unit of at least one of: a bandwidth part (BWP), a sub-band, or a physical resource block (PRB).

Aspect 7: The method of any one of Aspects 1-6, wherein the reference signal is: a channel state information reference signal (CSI-RS), a tracking reference signal (TRS), a downlink demodulation reference signal (DMRS), or an uplink DMRS.

Aspect 8: The method of any one of Aspects 1-8, further comprising: transmitting or receiving the reference signal based at least in part on the time-domain density configuration.

Aspect 9: A method of wireless communication performed by a user equipment (UE), comprising: obtaining an indication of a time-domain density configuration associated with a reference signal; and transmitting or receiving the reference signal based at least in part on a transmission frequency associated with the reference signal and the time-domain density configuration.

Aspect 10: The method of Aspect 9, wherein the transmission frequency is a first transmission frequency, wherein the time-domain density configuration is a first time-domain density configuration, wherein the indication is a first indication, and the method further comprises: obtaining a second time-domain density configuration for the reference signal based at least in part on a second transmission frequency associated with the reference signal, wherein the first transmission frequency is different from the second transmission frequency.

Aspect 11: The method of Aspect 9 or Aspect 10, wherein at least one of the first time-domain density configuration or the second time-domain density configuration indicate an antenna port associated with transmitting the reference signal.

Aspect 12: The method of any one of Aspects 9-11, wherein the second transmission frequency is higher than the first transmission frequency, wherein the first time-domain density configuration is based at least in part on a first number of time units, wherein the second time-domain density configuration is based at least in part on a second number of time units, and wherein the second number is larger than the first number.

Aspect 13: The method of Aspect 12, wherein a time unit is at least one of: a symbol, a time slot, a mini-slot, or a time duration.

Aspect 14: The method of any one of Aspects 9-13, wherein the time-domain density configuration indicates a time-domain density that is based at least in part on a frequency unit of at least one of: a bandwidth part (BWP), a sub-band, or a physical resource block (PRB).

Aspect 15: The method of any one of Aspects 9-14, wherein the reference signal is: a channel state information reference signal (CSI-RS), a tracking reference signal (TRS), a downlink demodulation reference signal (DMRS), or an uplink DMRS.

Aspect 16: The method of any one of Aspects 9-15, wherein obtaining the indication of the time-domain density configuration further comprises: receiving the indication of the time-domain density configuration from a network entity; or obtaining a pre-configured time-domain density configuration.

Aspect 17: An apparatus for wireless communication at a device, comprising a processor; memory coupled with the processor; and instructions stored in the memory and executable by the processor to cause the apparatus to perform the method of one or more of Aspects 1-8.

Aspect 18: An apparatus for wireless communication at a device, comprising a processor; memory coupled with the processor; and instructions stored in the memory and executable by the processor to cause the apparatus to perform the method of one or more of Aspects 9-16.

Aspect 19: A device for wireless communication, comprising a memory and one or more processors coupled to the memory, the one or more processors configured to perform the method of one or more of Aspects 1-8.

Aspect 20: A device for wireless communication, comprising a memory and one or more processors coupled to the memory, the one or more processors configured to perform the method of one or more of Aspects 9-16.

Aspect 21: An apparatus for wireless communication, comprising at least one means for performing the method of one or more of Aspects 1-8.

Aspect 22: An apparatus for wireless communication, comprising at least one means for performing the method of one or more of Aspects 9-16.

Aspect 23: A non-transitory computer-readable medium storing code for wireless communication, the code comprising instructions executable by a processor to perform the method of one or more of Aspects 1-8.

Aspect 24: A non-transitory computer-readable medium storing code for wireless communication, the code comprising instructions executable by a processor to perform the method of one or more of Aspects 9-16.

Aspect 25: A non-transitory computer-readable medium storing a set of instructions for wireless communication, the set of instructions comprising one or more instructions that, when executed by one or more processors of a device, cause the device to perform the method of one or more of Aspects 1-8.

Aspect 26: A non-transitory computer-readable medium storing a set of instructions for wireless communication, the set of instructions comprising one or more instructions that, when executed by one or more processors of a device, cause the device to perform the method of one or more of Aspects 9-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a network entity, comprising:
a memory; and
one or more processors, coupled to the memory, configured to cause the apparatus to:
select a time-domain density configuration for a reference signal based at least in part on a transmission frequency associated with the reference signal; and
transmit an indication of the time-domain density configuration to a user equipment (UE).

2. The apparatus of claim 1, wherein the transmission frequency is a first transmission frequency, wherein the time-domain density configuration is a first time-domain density configuration, wherein the indication is a first indication, and the one or more processors are further configured to cause the apparatus to:
select a second time-domain density configuration for the reference signal based at least in part on a second transmission frequency associated with the reference signal, and
transmit an indication of the second time-domain density configuration to the UE,
wherein the first transmission frequency is different from the second transmission frequency.

3. The apparatus of claim 2, wherein at least one of the first time-domain density configuration or the second time-domain density configuration indicate an antenna port associated with transmitting the reference signal.

4. The apparatus of claim 2, wherein the second transmission frequency is higher than the first transmission frequency,
wherein the first time-domain density configuration is based at least in part on a first number of time units,
wherein the second time-domain density configuration is based at least in part on a second number of time units, and
wherein the second number is larger than the first number.

5. The apparatus of claim 4, wherein a time unit is at least one of:
a symbol,
a time slot,
a mini-slot, or
a time duration.

6. The apparatus of claim 1, wherein the time-domain density configuration indicates a time-domain density that is based at least in part on a frequency unit of at least one of:
a bandwidth part (BWP),
a sub-band, or
a physical resource block (PRB).

7. The apparatus of claim 1, wherein the reference signal is:
a channel state information reference signal (CSI-RS),
a tracking reference signal (TRS),
a downlink demodulation reference signal (DMRS), or
an uplink DMRS.

8. The apparatus of claim 1, wherein the one or more processors are further configured to cause the apparatus to:
transmit or receive the reference signal based at least in part on the time-domain density configuration.

9. An apparatus for wireless communication at a user equipment (UE), comprising:
a memory; and
one or more processors, coupled to the memory, configured to cause the apparatus to:
obtain an indication of a time-domain density configuration associated with a reference signal; and
transmit or receiving the reference signal based at least in part on a transmission frequency associated with the reference signal and the time-domain density configuration.

10. The apparatus of claim 9, wherein the transmission frequency is a first transmission frequency, wherein the time-domain density configuration is a first time-domain density configuration, wherein the indication is a first indication, and the one or more processors are further configured to cause the apparatus to:
obtain a second time-domain density configuration for the reference signal based at least in part on a second transmission frequency associated with the reference signal,
wherein the first transmission frequency is different from the second transmission frequency.

11. The apparatus of claim 10, wherein at least one of the first time-domain density configuration or the second time-domain density configuration indicate an antenna port associated with transmitting the reference signal.

12. The apparatus of claim 10, wherein the second transmission frequency is higher than the first transmission frequency,
wherein the first time-domain density configuration is based at least in part on a first number of time units,
wherein the second time-domain density configuration is based at least in part on a second number of time units, and
wherein the second number is larger than the first number.

13. The apparatus of claim 12, wherein a time unit is at least one of:
a symbol,
a time slot,
a mini-slot, or
a time duration.

14. The apparatus of claim 9, wherein the time-domain density configuration indicates a time-domain density that is based at least in part on a frequency unit of at least one of:
a bandwidth part (BWP),
a sub-band, or
a physical resource block (PRB).

15. The apparatus of claim 9, wherein the reference signal is:
a channel state information reference signal (CSI-RS),
a tracking reference signal (TRS),
a downlink demodulation reference signal (DMRS), or
an uplink DMRS.

16. The apparatus of claim 9, wherein the one or more processors, to obtain the indication of the time-domain density configuration, are configured to cause the apparatus to:
receive the indication of the time-domain density configuration from a network entity; or
obtain a pre-configured time-domain density configuration.

17. A method of wireless communication performed by a network entity, comprising:
selecting a time-domain density configuration for a reference signal based at least in part on a transmission frequency associated with the reference signal; and
transmitting an indication of the time-domain density configuration to a user equipment (UE).

18. The method of claim 17, wherein the transmission frequency is a first transmission frequency, wherein the time-domain density configuration is a first time-domain density configuration, wherein the indication is a first indication, and the method further comprises:
selecting a second time-domain density configuration for the reference signal based at least in part on a second transmission frequency associated with the reference signal, and
transmitting an indication of the second time-domain density configuration to the UE,
wherein the first transmission frequency is different from the second transmission frequency.

19. The method of claim 18, at least one of the first time-domain density configuration or the second time-domain density configuration indicate an antenna port associated with transmitting the reference signal.

20. The method of claim 18, wherein the second transmission frequency is higher than the first transmission frequency,
wherein the first time-domain density configuration is based at least in part on a first number of time units,
wherein the second time-domain density configuration is based at least in part on a second number of time units, and
wherein the second number is larger than the first number.

21. The method of claim 17, wherein the time-domain density configuration indicates a time-domain density that is based at least in part on a frequency unit of at least one of:
a bandwidth part (BWP),
a sub-band, or
a physical resource block (PRB).

22. The method of claim 17, wherein the reference signal is:
a channel state information reference signal (CSI-RS),
a tracking reference signal (TRS),
a downlink demodulation reference signal (DMRS), or
an uplink DMRS.

23. The method of claim 17, further comprising:
transmitting or receiving the reference signal based at least in part on the time-domain density configuration.

24. A method of wireless communication performed by a user equipment (UE), comprising:
obtaining an indication of a time-domain density configuration associated with a reference signal; and
transmitting or receiving the reference signal based at least in part on a transmission frequency associated with the reference signal and the time-domain density configuration.

25. The method of claim 24, wherein the transmission frequency is a first transmission frequency, wherein the time-domain density configuration is a first time-domain density configuration, wherein the indication is a first indication, and the method further comprises:
obtaining a second time-domain density configuration for the reference signal based at least in part on a second transmission frequency associated with the reference signal,
wherein the first transmission frequency is different from the second transmission frequency.

26. The method of claim 25, wherein at least one of the first time-domain density configuration or the second time-domain density configuration indicate an antenna port associated with transmitting the reference signal.

27. The method of claim 25, wherein the second transmission frequency is higher than the first transmission frequency,
wherein the first time-domain density configuration is based at least in part on a first number of time units,
wherein the second time-domain density configuration is based at least in part on a second number of time units, and
wherein the second number is larger than the first number.

28. The method of claim 27, wherein a time unit is at least one of:
a symbol,
a time slot,
a mini-slot, or
a time duration.

29. The method of claim 24, wherein the reference signal is:
a channel state information reference signal (CSI-RS),
a tracking reference signal (TRS),
a downlink demodulation reference signal (DMRS), or
an uplink DMRS.

30. The method of claim 24, wherein obtaining the indication of the time-domain density configuration further comprises:
receiving the indication of the time-domain density configuration from a network entity; or
obtaining a pre-configured time-domain density configuration.
